(19) United States
(12) Patent Application Publication
(10) Pub. No.: US 2025/0203031 A1
(43) Pub. Date: Jun. 19, 2025

(54) COMMUNICATION APPARATUS, METHOD FOR CONTROLLING COMMUNICATION APPARATUS, AND STORAGE MEDIUM

(71) Applicant: CANON KABUSHIKI KAISHA, Tokyo (JP)

(72) Inventors: TAKUMI MAEDA, Kanagawa (JP); YUICHI YAGI, Tokyo (JP)

(21) Appl. No.: 18/972,445

(22) Filed: Dec. 6, 2024

(30) Foreign Application Priority Data
Dec. 14, 2023 (JP) 2023-211517

(51) Int. Cl. H04N 1/327; H04W 76/15; H04W 84/12

(52) U.S. Cl. CPC H04N 1/32771; H04W 76/15; H04N 2201/0094; H04W 84/12

(57) ABSTRACT

A communication apparatus performs wireless communication with an external apparatus compliant with an IEEE 802.11be standard. The communication apparatus establishes a link between the external apparatus and the communication apparatus by a communication function compliant with the IEEE 802.11be standard, and executes, based on a job that the communication apparatus is holding, predetermined processing for controlling whether to execute a first communication using a first plural number of links between the external apparatus and the communication apparatus, or to execute a second communication using a second plural number of links smaller than the first plural number between the external apparatus and the communication apparatus.

### BACKGROUND

### Field

The present disclosure relates to a communication apparatus, a method for controlling the communication apparatus, and a storage medium.

### Description of the Related Art

There is a technique of dynamically switching a connection destination AP in order to efficiently exchange data between an access point (AP) and a station (STA) in an extended service set (ESS) constituted by a plurality of APs. When, based on the state of congestion of an AP to which an STA is connected, the degree to which another AP is free, radio wave conditions, and the like, it is determined that the connection destination AP should be switched, the connected AP transmits to the STA a request to change the AP to which it is connected. The STA can connect to an appropriate AP by switching the connection destination AP according to the request when it receives the request to change the AP.

Japanese Patent Laid-Open No. 2018-50133 discloses the following as processing for making a request, from a router with an AP function to a connected wireless child device, to change a connection destination. A mobile router (MR1) that can be connected to a plurality of wireless child devices confirms whether a wireless child device terminal supports IEEE 802.11v. Whether or not the wireless child device terminal supports IEEE 802.11v can be determined from an Association Request frame transmitted when the wireless child device terminal wirelessly connects to MR1. In a case where the wireless child device terminal supports IEEE 802.11v, a BSS Transition Management (BTM) Request frame is transmitted to the corresponding wireless child device terminal. In a BSS Transition Candidate List Entries field of the BTM Request frame, a BSS ID of a parent router RT2 is designated as the connection destination. Thereby, a switching of the connection destination of the child device terminal is prompted, and the wireless child device terminal switches the connection destination from MR1 to RT2 in accordance with the received BTM Request frame.

In addition, in the newly established IEEE 802.11be standard, a plurality of wireless links are established between a communication device acting as an AP and another communication device acting as an STA via a plurality of different frequency channels, and Multi-Link communication in which communication is performed in parallel on those links is realized.

It is desirable to better control the execution of communication using a plurality of links in an environment where such communication can be employed.

### SUMMARY

The present disclosure more appropriately controls the execution of communication using a plurality of links.

An aspect of the present disclosure provides a communication apparatus for performing wireless communication with an external apparatus compliant with an IEEE 802.11be standard, the communication apparatus comprising: at least one memory storing instructions; and at least one processor that is in communication with the at least one memory and that, when executing the instructions, cooperates with the at least one memory to execute processing, the processing including: establishing a link between the external apparatus and the communication apparatus by a communication function compliant with the IEEE 802.11be standard; and executing, based on a job that the communication apparatus is holding, predetermined processing for controlling whether to execute a first communication using a first plural number of links between the external apparatus and the communication apparatus established by the communication function compliant with the IEEE 802.11be standard as the communication between the external apparatus and the communication apparatus, or to execute a second communication using a second plural number of links smaller than the first plural number between the external apparatus and the communication apparatus established by the communication function compliant with the IEEE 802.11be standard as the communication between the external apparatus and the communication apparatus.

According to the present disclosure, it is possible to more appropriately control the execution of communication using a plurality of links.

Further features of the present disclosure will become apparent from the following description of exemplary embodiments with reference to the attached drawings.

### BRIEF DESCRIPTION OF THE DRAWINGS

FIG. 1 is a view illustrating an example of a network configuration.

FIG. 2 is a sequence diagram for when Multi-Link communication is performed.

FIG. 3 is a view illustrating an RNR element format.

FIG. 4 is a view illustrating an example of a hardware configuration of an AP and an STA.

FIG. 5 is a view illustrating an example of a functional configuration of an AP and an STA.

FIG. 6A is a flowchart of processing for determining whether to perform Multi-Link communication according to a first embodiment.

FIG. 6B is a flowchart of processing for determining whether to perform Multi-Link communication according to the first embodiment.

FIG. 7 is a flowchart of processing for determining whether to perform Multi-Link communication according to a second embodiment.

FIG. 8 is a view illustrating an example of a configuration of a storage unit and a storage region that an STA comprises.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

Hereinafter, embodiments of the present disclosure will be described in detail with reference to the accompanying drawings.

### Configuration of Wireless Communication System

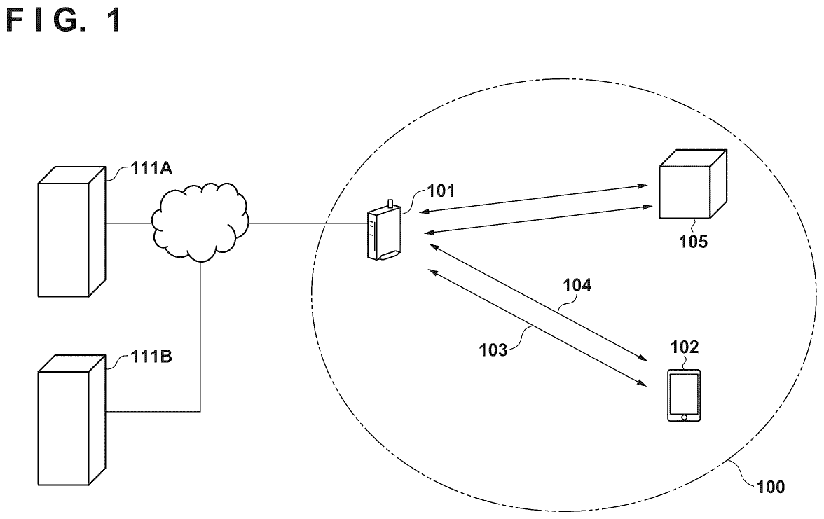

FIG. 1 illustrates a configuration example of a communication network according to the present embodiment. FIG. 1 illustrates a configuration including one access point (AP) 101 and two wireless child devices 102 and 105. The wireless child devices are stations, and are hereinafter referred to as STAs. In the present embodiment, each of the AP 101 and the STAs 102, 105 corresponds to one apparatus. Specifically, for example, the AP 101 is a single external apparatus and is a single wireless Local Area Network (LAN) router. Also, for example, the STA 105 is specifically a single printer. As illustrated in FIG. 1, the communication network formed by the AP 101 is indicated by a circle 100. The AP 101 and the STAs 102, 105 can transmit and receive signals to and from each other. Hereinafter, a communication network configured by wireless communication may be simply referred to as a network or a wireless network. The STAs 102, 105 may also be referred to as child devices, wireless child devices, or wireless terminals. Also, the AP 101 and the STAs 102, 105 may be referred to as communication apparatuses or communication devices.

The STAs 102, 105 join a network that the AP 101 forms, and the AP 101 and the STAs 102, 105 can perform wireless communication compliant with an IEEE 802.11be (EHT) standard. Note that IEEE is an abbreviation for Institute of Electrical and Electronics Engineers. EHT is also an abbreviation for Extremely High Throughput. IEEE 802.11be is also referred to as Wi-Fi 7 (registered trademark). In EHT, communication apparatuses can communicate on frequencies in a 2.4 GHz band, a 5 GHz band, and a 6 GHz band. The frequency bands used by the respective communication apparatuses are not limited thereto, and may be different frequency bands, such as a 60 GHz band. Also, the AP 101 and the STAs 102, 105 may communicate using 20 GHz, 40 MHz, 80 MHz, 160 MHz, and 320 MHz bandwidths. The bandwidths used by the respective communication apparatuses are not limited thereto, and different bandwidths, such as 240 MHz and 4 MHz may be used.

Note that the AP 101 and the STAs 102, 105 support the IEEE 802.11be standard, but may also support a legacy standard that is a standard prior to the IEEE 802.11be standard, and may support a subsequent standard to IEEE 802.11be. Specifically, the AP 101 and the STA 102 may support at least one of IEEE 802.11a/b/g/n/ac/ax standards. Further, in addition to IEEE 802.11 series standards, other communication standards such as Bluetooth (registered trademark), NFC, UWB, ZigBee, and MBOA may be supported. Note that UWB is an abbreviation of Ultra Wide Band, and MBOA is an abbreviation of Multi Band OFDM Alliance. In addition, NFC is an abbreviation of Near Field Communication. UWB includes wireless USB, wireless 1394, WiNET, and the like. Further, the AP 101 may support a wired communication standard such as wired LAN. Concrete examples of the AP 101 include, but are not limited to, a wireless LAN router, a personal computer (PC), a single-function access point, and the like. The AP 101 may be an information processing apparatus such as a wireless chip capable of performing wireless communication compliant with the IEEE 802.11be standard. Further, specific examples of the STA 102 include, but are not limited to, a camera, a tablet terminal, a smartphone, a personal computer (PC), a mobile phone, a video camera, a headset, and the like. The STA 102 may be an information processing apparatus such as a wireless chip capable of performing wireless communication compliant with the IEEE 802.11be standard. Further, a specific example of the STA 105 is an image forming apparatus having multiple functions such as a printer for forming an image and a scanner for reading an image.

The STA 105 is, for example, an image forming apparatus such as a single-function printer or a digital multifunction peripheral including a scanner for optically reading an image. This image forming apparatus is an STA to the AP 101, and is therefore called the STA 105 and may also be called the communication apparatus 105. The STA 105 is connected to the AP 101 by communication conforming to the IEEE 802.11be standard. Units of processing specific to an image forming apparatus such as image forming or image reading executed by the STA 105 are called jobs, and the STA 105 can execute in parallel a plurality of jobs for which resources to be used do not conflict. For example, the STA 105 can execute a scan job and a print job, which does not use a scanner, in parallel.

Servers 111A, 111B are so-called cloud servers arranged on the Internet. One or both of them have a function of a print server that stores print data received from a terminal and transmits the print data to the STA 105 in response to a request or without a request. Although the servers 111A, 111B are cloud servers, they may be connected to the AP 101 by wireless communication according to IEEE 802.11be. The servers 111A, 111B may be servers that provide a service other than that of a print server. In the following description, the description of the STA 102 also applies to the STA 105 which is an image forming apparatus. Note that configuration may be such that only one of the servers 111A, 111B is present, and configuration may be such that three or more servers are present.

The AP 101 and the STAs 102, 105 establish a plurality of links via a plurality of frequency channels and perform Multi-Link communication to communicate with each other. An AP corresponding to a single apparatus that executes Multi-Link communication and an STA corresponding to a single apparatus include a plurality of virtual APs and a plurality of virtual STAs, respectively. Therefore, an AP corresponding to one apparatus and an STA corresponding to one apparatus are also referred to as an AP multi-link device (AP MLD) and an STA multi-link device (STA MLD), respectively. An STA MLD is sometimes called a non-AP MLD. An AP MLD and an STA MLD may be referred to as communication apparatuses or communication devices. A virtual AP and a virtual STA are referred to as an affiliated AP and an affiliated STA. A plurality of affiliated APs included in one AP MLD are APs that each communicate using different channels. Similarly, a plurality of affiliated STAs included in one STA MLD are STAs that each communicate using different channels. In the IEEE 802.11 series standard, the bandwidth of a frequency channel is defined as 20 MHz. Here, a frequency channel is a frequency channel defined in the IEEE 802.11 series standard, and in the IEEE 802.11 series standard, a plurality of frequency channels are defined in the respective frequency bands of a 2.4 GHz band, a 5 GHz band, a 6 GHz band, and a 60 GHz band. Therefore, a plurality of affiliated APs and a plurality of affiliated STAs use any of the above-described frequency channels. Note that a bandwidth of 40 MHz or more may be used in one frequency channel by bonding to a neighboring frequency channel. For example, the AP 101 may establish a link 103 via a first frequency channel of the 5 GHz band with the STA 102 and communicate thereover. In parallel to this, the STAs 102, 105 may establish a link 104 via a second frequency channel of the 6 GHz band with the AP 102 and communicate thereover. In this case, in parallel to the link 103 via the first frequency channel, the STAs 102, 105 perform Multi-Link communication which maintains the second link 104 via the second frequency channel. Below, in a case where the AP 101 and the STAs 102, 105 support Multi-Link communication, to distinguish them from individual APs and STAs included therein, the AP 101 will be referred to as the AP MLD 101, and the STAs 102, 105 will be referred to as the STA MLDs 102, 105. However, in a case where there is no risk of confusion, they will be referred to as the AP 101 and the STAs 102, 105.

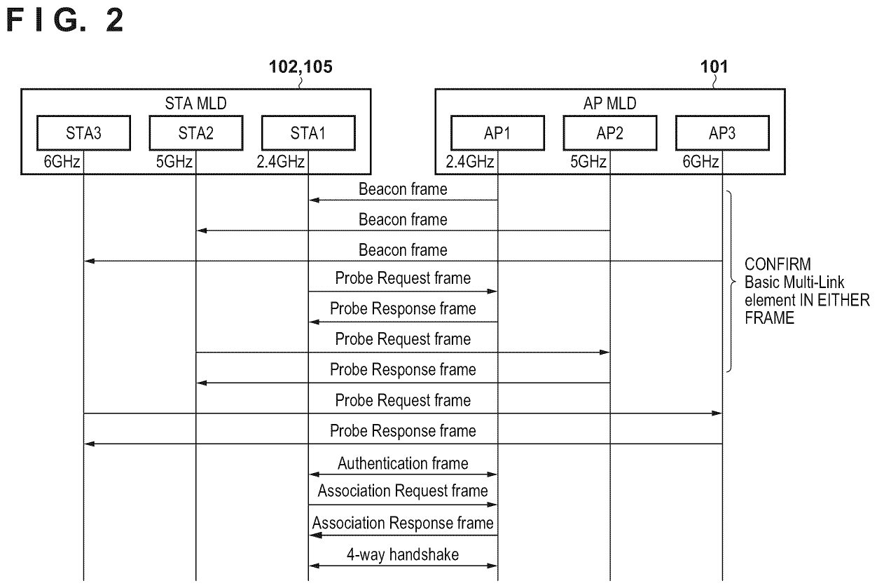

FIG. 2 illustrates an exemplary sequence diagram for when Multi-Link communication is performed. In FIG. 2, affiliated APs will be given suffix numbers such as AP1, AP2 . . . , and affiliated STAs will be given suffix numbers such as STA1, STA2. . . . That is, in FIG. 2, for example, the AP MLD 101 includes a first AP, AP1, a second AP, AP2, and a third AP, AP3. Each of the STA MLDs 102, 105 includes a first STA, STA1, a second STA, STA2, and a third STA, STA3. AP1 and STA1 establish a first link using a first frequency channel. AP2 and STA2 establish a second link using a second frequency channel. AP3 and STA3 establish a third link using a third frequency channel. In the present embodiment, a connection between an affiliated STA and an affiliated AP is called a link. The first frequency channel to the third frequency channel are in the 2.4 GHz band, 5 GHz band, and 6 GHz band, respectively, in the example of FIG. 2, but may be in other available frequency bands. In this case, the number of APs included in the AP MLD is not limited to three, and may be a number corresponding to available frequency bands. It is similar for the STA MLD. As described above, an AP that is associated with a respective frequency band and that is capable of performing data communication is referred to as an affiliated AP, and an STA that is associated with a respective frequency band and that capable of performing data communication is referred to as an affiliated STA. An affiliated AP and an affiliated STA may be set in advance by a user such as an administrator from among APs that the AP MLD 101 includes and the STAs that the STA MLDs 102, 105 includes, for example. The determination of whether to connect by Multi-Link is based on a Basic Multi-Link element. The AP MLD transmits the Basic Multi-Link element on a Beacon or a Probe Response in response to a Probe Request from an STA. The STA MLD determines whether the Basic Multi-Link element is included in a Beacon or Probe Response emitted by any affiliated AP and determines whether it is AP MLD or not. If a Basic Multi-Link element is included, it can be determined that the transmission origin AP is the AP MLD.

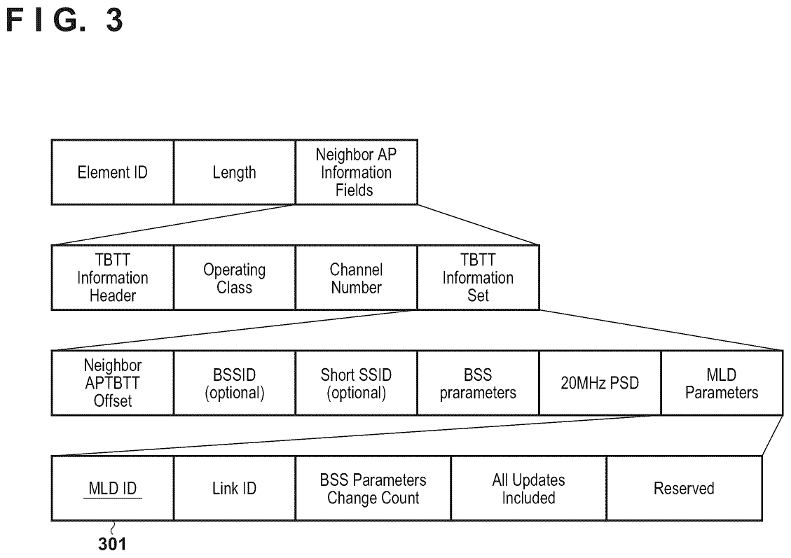

In a case where a communication partner AP (hereinafter, referred to as the partner AP) is the AP MLD, the frequency band and channel information of other affiliated APs belonging to the same AP MLD are acquired from a Reduced Neighbor Report (RNR) element included in the acquired Beacon or Probe Response. It can be determined that it is the same AP MLD by the fact that an MLD ID included in the RNR element is 0. The format of the RNR element is illustrated in FIG. 3. The RNR element includes an MLD ID 301 as illustrated in FIG. 3. The STA MLD switches to a frequency band and channel indicated by the acquired channel information, acquires detailed information of each affiliated AP, and connects by Multi-Link to the affiliated AP to which connection is desired based thereon. In a case where the partner AP is not the AP MLD, it is connected by a single frequency channel. When the STA and the AP establish a connection, STA1 first makes a request to AP1 for authentication by an Authentication Frame, and when the authentication succeeds, STA1 transmits an Association Request to AP1. AP1 performs an association by returning an Association Response. After that, a 4-way handshake is performed to install an encryption/decryption key.

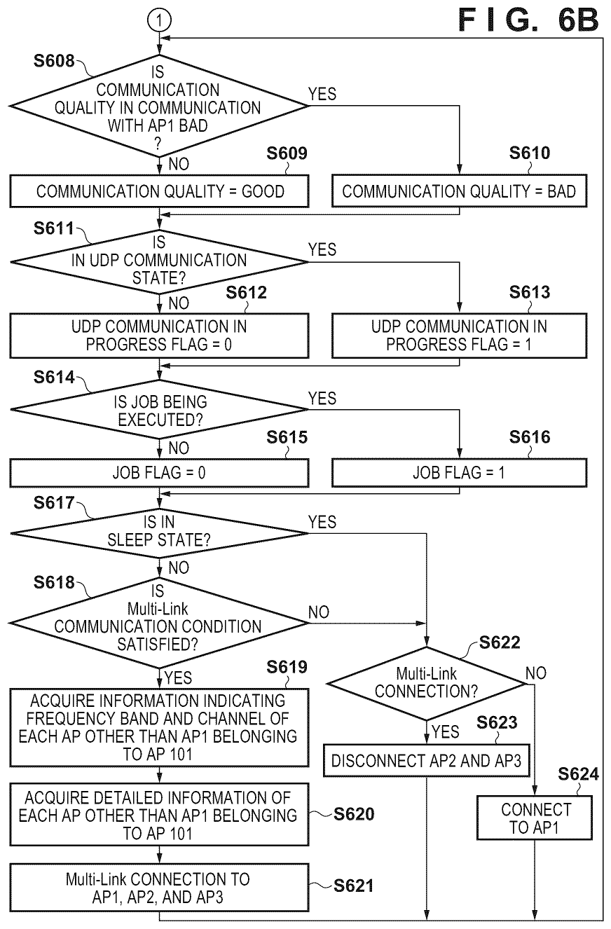

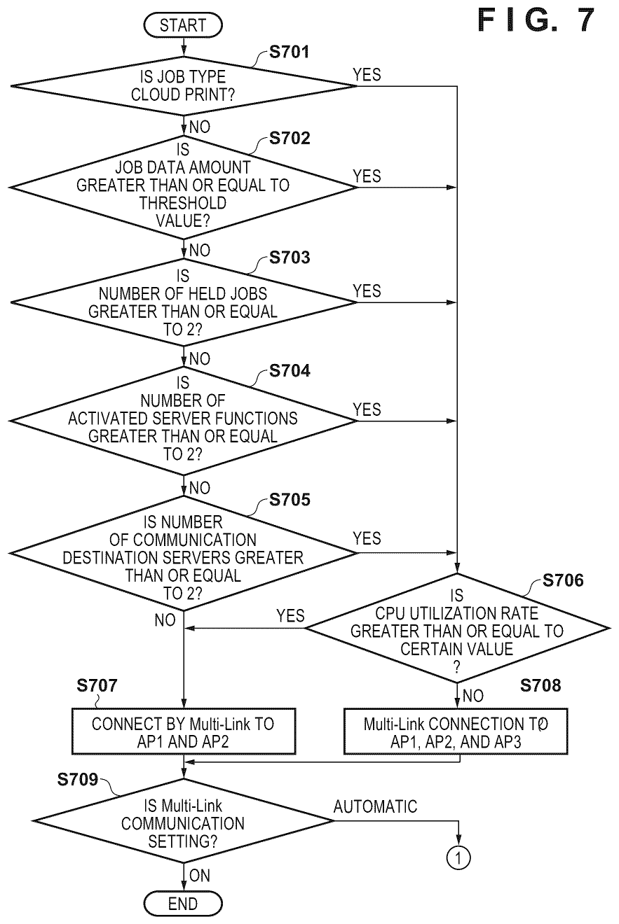

By establishing a plurality of links through a plurality of frequency channels between the AP 101 and the STAs 102, 105 as described above, it is possible to improve the throughput of communication between the AP 101 and each of the STAs 102, 105. In the present embodiment, as described in the first and second embodiments to be described later, the STAs 102, 105 do not unconditionally set multi-link even if a received beacon/probe response indicates that the AP 101 is the AP MLD. Multi-link is set, or the number of the links is changed in accordance with the situation. This will be described with reference to FIGS. 6A and 6B and FIG. 7.

In Multi-Link communication, a plurality of links having different frequency bands may be established as the links between the communication devices. For example, the AP 101 and the STA 102 may establish a third link in the 2.4 GHz band in addition to the link 103 in the 5 GHz band and the link 104 in the 6 GHz band. Alternatively, links may be established through a plurality of different channels included in the same frequency band. For example, 15 ch in the 6 GHz band may be established as a first link, and 207 ch in the 6 GHz band may be established as a second link. Note that links having the same frequency band and links having different frequency bands may be mixed. For example, a link of 149 ch in the 5 GHz band and a link of 15 ch in the 6 GHz band may be established in addition to the link 103 of 36 ch in the 5 GHz band between the AP 101 and each of the STAs 102, 105. The AP 101, by establishing a plurality of connections on different frequencies with the STA 102, can establish communication in another band with the STA 102 in a case where a certain band is congested, and thereby can prevent a deterioration in throughput in communication with the STA 102 and communication delays. It is similar for the STA 105.

### Configuration of AP, STA

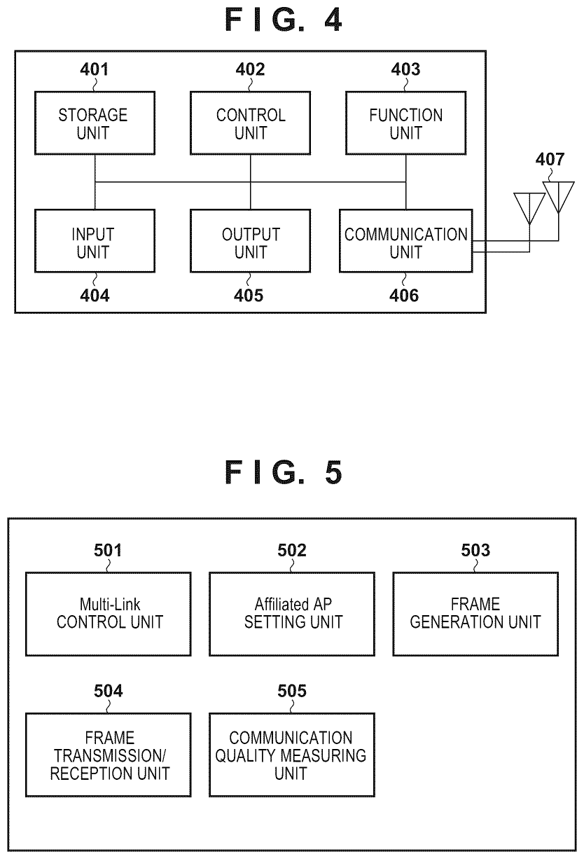

FIG. 4 illustrates an exemplary hardware configuration of the AP 101 according to the present embodiment. The AP 101 includes a storage unit 401, a control unit 402, a function unit 403, an input unit 404, an output unit 405, a communication unit 406, and an antenna 407. Note that a plurality of antennas may be used.

The storage unit 401 is configured to include one or more memories such as a nonvolatile storage device (such as a ROM) and a RAM or the like, and stores a computer program for performing various operations to be described later and various types of information such as communication parameters for wireless communication. ROM is an abbreviation for Read Only Memory and the RAM is an abbreviation for Random Access Memory. As the storage unit 401, in addition to a memory such as a ROM or a RAM, a storage medium such as a flexible disk, a hard disk, an optical disk, a magneto-optical disk, a CD-ROM, a CD-R, a magnetic tape, a nonvolatile memory card, or a DVD may be used. Further, the storage unit 401 may include a plurality of memories and the like.

The control unit 402 is constituted by, for example, one or more processors such as a CPU and an MPU, and controls the AP 101 as a whole by executing a computer program stored in the storage unit 401. The control unit 402 may control the AP 101 as a whole in cooperation with a computer program and an Operating System (OS) stored in the storage unit 401. In addition, the control unit 402 generates data and signals (wireless frames) to be transmitted in communication with other communication apparatuses. Note that CPU is an abbreviation for Central Processing Unit, and MPU is an abbreviation for Micro Processing Unit. In addition, the control unit 402 may include a plurality of processors such as a multi-core processor, and the AP 101 as a whole may be controlled by the plurality of processors.

Further, the control unit 402 controls the function unit 403 to execute predetermined processing such as wireless communication, imaging, printing, and projection. The function unit 403 is hardware for the AP 101 to execute predetermined processing.

The input unit 404 accepts various operations from the user. The output unit 405 performs various types of output to the user via a monitor screen or a speaker. Here, output by the output unit 405 may be display on a monitor screen, an audio output by a speaker, a vibration output, or the like. Note that both the input unit 404 and the output unit 405 may be realized by a single module as in the case of a touch panel. The input unit 404 and the output unit 405 may be integrated with the AP 101 or they may be separate bodies.

The communication unit 406 controls wireless communication compliant with the IEEE 802.11be standard. In addition to the IEEE 802.11be standard, the communication unit 406 may perform control of wireless communication compliant with another IEEE 802.11 series standard, or control of wired communication such as wired LAN. The communication unit 406 controls the antenna 407 to transmit and receive signals for wireless communication generated by the control unit 402.

In a case where the AP 101 complies with an NFC standard, a Bluetooth standard, or the like in addition to the IEEE 802.11be standard, wireless communication may be controlled in compliance with those communication standards. In addition, in a case where the AP 101 is capable of performing wireless communication compliant with a plurality of communication standards, it may be configured to individually include a communication unit and an antenna that are compliant with the respective communication standards. The AP 101 communicates data such as image data, document data, and video data with a partner device via the communication unit 406. Note that the antenna 407 may be configured separately from the communication unit 406 or may be configured as a single module together with the communication unit 406.

The antenna 407 is an antenna capable of communication in the 2.4 GHz band, the 5 GHz band, and the 6 GHz band. In the present embodiment, the AP 102 has two antennas, but may have three antennas. Alternatively, different antennas may be provided for each frequency band. In a case where the AP 101 includes a plurality of antennas, it may include a communication unit 406 corresponding to each antenna.

The STAs 102, 105 have similar hardware configurations to the AP 101 illustrated in FIG. 4. Since the STA 105 is, for example, an image forming apparatus, it may include, in addition to the configuration of FIG. 4, an image forming unit (printer unit) of an ink jet system or an electrophotographic system or the like, a reading unit (scanner unit) that reads an image recorded on a paper document or the like, and control units for these. Further, the STA 105 may include an image processing unit for processing an image to be printed or a read image, and a storage unit for storing print data received from a terminal or a server. The configurations of the STA 105 illustrated in FIG. 4 are referred to as a controller unit in distinction from configurations unique to an image forming apparatus such as an image forming unit and a scanner unit. The STA 102 is similar to the STA 105, but the STA 102 may be a different apparatus to the STA 105. For example, the STA 102 may include at least one of a printer unit that prints image data on a medium and a scanner unit that reads an original. In addition, the STA 102 may include a camera unit that performs imaging. That is, the STA 102 may be an image processing apparatus such as a printer, a scanner, or an MFP, or may be a mobile terminal such as a smart phone or a tablet, a camera, or a personal computer (PC).

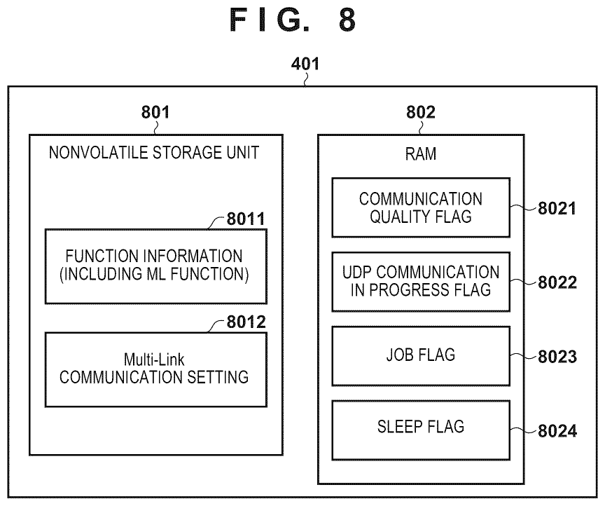

FIG. 8 illustrates an exemplary configuration and a storage region of the storage unit 401 included in the STAs 102, 105 according to the present embodiment. The storage unit 401 includes a nonvolatile storage unit 801 and a RAM 802. The nonvolatile storage unit 801 includes function information 8011 indicating functions that the STAs 102, 105 comprise and a Multi-Link communication setting 8012 set by a user, for example. The function information 8011 includes multi-link support information indicating whether or not the STAs 102, 105 support Multi-Link communication. The Multi-Link communication setting 8012 is set by the user, from a user interface that the STAs 102, 105 comprise, or remotely via communication. The setting may be either to perform Multi-Link communication (on), not to perform it (off), or to determine whether to perform it automatically. The RAM 802 includes a communication quality flag 8021 indicating whether or not the quality of the most recent communication with the partner AP was good, and a UDP communication in progress flag 8022 indicating that UDP communication is being performed. The RAM 802 further includes a job flag 8023 indicating that a job is being executed by STA 105 that is an image forming apparatus, and includes a sleep flag 8024 indicating whether the STA 105 is in a sleep state. The sleep state is a power saving state from which a normal operation state is restored in response to reception of a signal or an operation input, and is, for example, a state in which power supply is stopped except for to the controller unit (refer to FIG. 4) of the image forming apparatus. The image forming apparatus 105 transitions from a normal operation state to a sleep state when a predetermined period of time has elapsed since the completion of the job, for example, and transitions from the sleep state to the normal operation state when a certain message is received or an operation is performed from a user interface (UI). Note that the sleep state is not limited to the above description, and a clock rate of the CPU may be lowered, or power supply to units other than a unit that receives a signal or accepts an operation input, such as the input unit 404 or the communication unit 406, may be stopped, even in the controller unit in the sleep state.

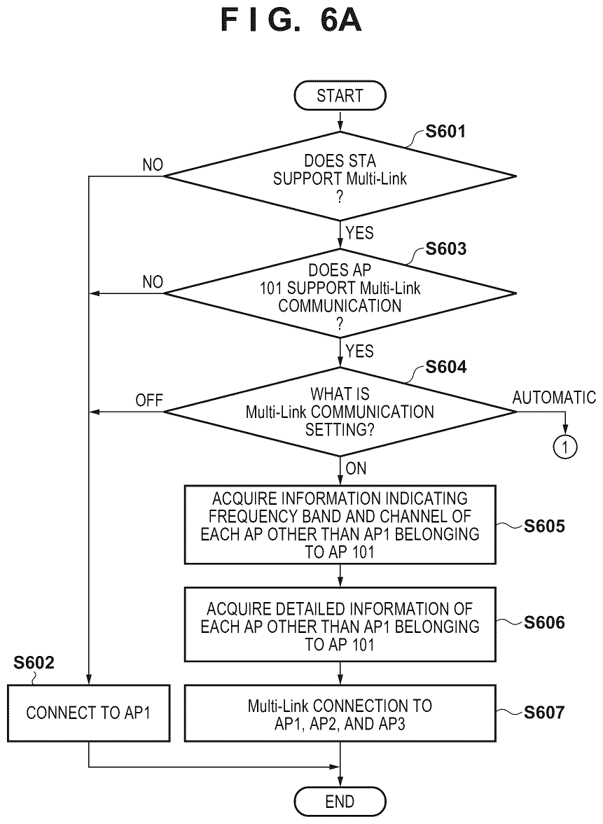

FIG. 5 illustrates a block diagram of a functional configuration of the AP 101 according to the present embodiment. The functional blocks illustrated here are realized by the control unit 402 executing a program for achieving the respective functions on the hardware illustrated in FIG. 4. Note that the STAs 102, 105 have similar configurations, but in the STA, an affiliated AP setting unit 502 is replaced with an affiliated STA setting unit, and the target of the setting is an affiliated STA.

The AP 101 is constituted by a multi-link control unit 501, the affiliated AP setting unit 502, a frame generation unit 503, a frame transmission/reception unit 504, and a communication quality measuring unit 505.

The multi-link control unit 501 is a block for controlling communication start processing (connection processing) for establishing one or more links used by the AP 101 for wireless communication with the STA 102, and processing for adding and deleting a link after starting communication, and communication end processing for deleting all links. Specifically, the connection processing is configured to include Authentication processing, Association processing, and 4-way handshake (4WHS) processing.

The affiliated AP setting unit 502 selects and determines an affiliated AP in the Multi-Link communication in accordance with the settings in the respective UI units. In addition, the frame transmission/reception unit 504 is notified of an affiliated AP to be used.

The frame generation unit 503 is a block that generates a frame to be transmitted in accordance with a setting of the affiliated AP setting unit 502.

The frame transmission/reception unit 504 performs processing in accordance with affiliated AP information received from the affiliated AP setting unit 502. Specifically, the frame transmission/reception unit 504 transmits a wireless frame including a Beacon/Probe Response frame and a data frame generated by the frame generation unit 503 and receives a wireless frame from a partner device, in accordance with the information.

The communication quality measuring unit 505 measures and calculates a communication quality of a Beacon/Probe Response frame received from the frame transmission/reception unit 504. Since the quality of a received signal from the STAs 102, 105 is evaluated in the AP 101, the communication quality of a frame received from an STA, such as a Probe Request frame, may be measured and calculated. The measured communication quality information may be not only a received radio field strength (RSSI), but also a signal-to-noise ratio (SNR), or the like, and is not limited thereto.

Incidentally, when an STA performs persistent Multi-Link communication during communication, exchange of frames with a plurality of APs occurs.

Therefore, when there is no communication or when the amount of communication is small, the processing load of the STA is larger, and together with the communication overhead being larger, the power consumption may also be larger than when performing communication on a single link. Therefore, it is necessary to determine a condition in which Multi-Link communication is required, and to switch between single link communication and Multi-Link communication at appropriate timings. In addition, in a case where printing or scanning is performed by the STA 105, job data needs to be received by the STA 105. In a case where the job data is uploaded from the STA 102, the job data needs to be transmitted by the STA 102. In such a case, if single link communication is performed using a single link, the data transmission is delayed as compared to Multi-Link communication, and the increased job processing time may cause a decrease in usability. Therefore, in the present embodiment, processing for solving such a problem is executed as described below.

### Processing Flow

Next, several embodiments of a flow of processing for selecting single link communication and Multi-Link communication as needed and determining a link count in Multi-Link communication, and a sequence in the wireless communication system, and the like, which are executed in the AP and STA as described above, in particular, in the STA, will be described.

### First Embodiment

FIGS. 6A and 6B illustrate processing for determining whether the STA 105 performs Multi-Link communication with the AP 101 using predetermined criteria. This processing is initiated when the STA 105 initiates an attempt to connect to the AP 101. This processing is realized by the control unit 402 of the STA 105, in particular, by a CPU executing a program stored in the storage unit 401. Although the STA 105 is given as an example in the following explanation, similar processing can be executed in the STA 102. For example, for step S614 and step S617, which are steps determining conditions related to an image forming apparatus, in the case of the STA 102 which is not an image forming apparatus, it may be determined that the conditions are not met.

First, in step S601, the control unit 402 of the STA 105 determines whether or not Multi-Link communication is supported. This determination may be made by referring to information included in the function information 8011 which indicates whether or not Multi-Link communication is supported. In a case where the STA 105 does not support Multi-Link communication, the processing branches to step S602. In step S602, the control unit 402 of the STA 102 determines that Multi-Link communication cannot be performed, and connects only to AP1 which operates on the same frequency channel as affiliated STA1 which is to be used. That is, the STA 105 connects to the AP 101 without executing Multi-Link communication. In a case where the STA 105 supports Multi-Link communication, the processing proceeds to the subsequent step S603 and the STA 105 operates under the premise that Multi-Link communication will be performed. In a case where the processing of this flowchart is performed only in an STA 105 which supports Multi-Link communication, this step may be omitted and the processing may be started from step S603. In addition, since only one link is established in step S601, the link may be established based on a normal IEEE 802.11 standard without using a Multi-Link communication function compliant with the IEEE 802.11be standard.

In step S603, the control unit 402 of the STA 105 determines whether or not the AP 101 supports Multi-Link communication. Whether or not the AP 101 supports Multi-Link communication is determined based on whether or not there is a Basic Multi-Link element in a Beacon/Probe Response frame of API acquired by STA1. The Basic Multi-Link element is present in a Beacon/Probe Response frame of a device that supports Multi-Link communication, and includes information on an affiliated AP/STA that can perform Multi-Link communication. If the Basic Multi-Link element is included in the Beacon/Probe Response frame, it is determined that the AP 101 supports Multi-Link communication, and the processing proceeds to step S604. In a case where there is no Basic Multi-Link element in the Beacon/Probe Response frame of AP1, the processing proceeds to step S602. In step S602, the control unit 402 of the STA 105 determines that the AP 101 is an AP that does not support Multi-Link communication, and connects only to AP1.

In step S604, the control unit 402 of the STA 105 confirms the setting of the Multi-Link communication setting 8012. In a case where the Multi-Link communication setting 8012 is set to off by a user operation on the input unit 404 of the STA 105, the processing proceeds to step S602, and in a case where it is set to on, the processing proceeds to step S605, and in a case where it is set to automatic, the processing proceeds to step S608. Automatic is a setting for dynamically changing whether or not to perform Multi-Link communication in accordance with the state of the STA 105.

In a case where Multi-Link communication setting is on, the control unit 402 of the STA 105, in step S605, acquires information indicating frequency bands and channels in which affiliated APs other than AP1 belonging to the AP 101 (which are assumed to be AP2 and AP3) are operating. The Basic Multi-Link element received in step STA may also include information of another AP group that does not belong to the AP 101. For this reason, in order to determine whether or not an affiliated AP belongs to the AP 101, the control unit 402 of the STA 105 makes a determination using a Reduced Neighbor Report (RNR) element in a Beacon/Probe Response frame of AP1 acquired by STA1 (refer to FIG. 3). Each affiliated AP group in the Basic Multi-Link element is given an MLD ID 301. In a case where this MLD ID 301 is 0, it indicates belonging to the AP MLD to which an affiliated AP that emits a Beacon/Probe Response frame acquired in step STA1 belongs. Therefore, by acquiring information indicating the frequency band and the channel of an affiliated AP for which the MLD ID is 0, it is possible to ascertain/identify the frequency band and the channel of the APs (AP2, AP3) other than API operating in the AP 101.

Further, in step S606, the control unit 402 of the STA 105 switches the frequency band and the channel used for communication to the frequency band and the channel of the ascertained AP2, AP3. Then, the control unit 402 of the STA 105 acquires a Beacon/Probe Response frame of AP2 and AP3 and shares detailed information of each of AP2 and AP3. The control unit 402 of the STA 105 in step S607 is connected to AP1, AP2, and AP3 by Multi-Link. That is, the STA 105 connects to the AP 101 in order to perform Multi-Link communication by establishing three links that are links with AP1, AP2, and AP3. The connection procedure includes authentication, association, and a 4-way handshake as illustrated in FIG. 2.

In step S608, the control unit 402 of the STA 105 determines whether or not the communication quality (the communication quality of AP1) in the communication between AP1 and the STA 105 is bad. That is, in the present embodiment, the execution of Multi-Link communication is controlled based on an element for the communication quality of AP1. Specifically, the control unit 402 of the STA 105 calculates the communication quality of AP1, and determines whether or not the calculated communication quality of AP1 is lower than a threshold value at the time of using MCS0 which is the lowest rate. In a case where the communication quality is below the threshold value, the processing proceeds to step S610; otherwise the processing proceeds to step S609. MCS is an abbreviation of Modulation and Coding Scheme and is an index of a combination of a wireless modulation scheme, a coding rate, and the like, and the MCS used varies depending on the communication environment. MCS0 is the lowest-throughput method and is used in a case where the communication environment is very bad. In the present embodiment, the received radio field strength (RSSI), which is based on radio waves transmitted from AP1 and received by the STA 105, is used as a value representing the communication quality. In step S609, the control unit 402 of the STA 105 determines that there is no problem in the communication environment in a case where the RSSI is equal to or exceeds the threshold value for when MCS0 is used, and records “good” in the communication quality flag 8021. In step S610, the control unit 402 of the STA 105 records “bad” in the communication quality flag 8021 in a case where the RSSI is below the threshold value for when using MCS0. For example, when −70 dBm is set as the threshold value, the communication quality flag 8021 is set to “good” if the RSSI is greater than or equal to −70 dBm, and the communication quality flag 8021 is set to “bad” if the RSSI is −71 dBm or less. In a case where an application whose downlink information amount is large is frequently used, the downlink communication quality measured by the STA 105 as the value representing the communication quality may be referenced. In a case where the uplink information amount is large, the uplink communication quality measured by the AP 101 may be obtained from the AP 101 and referenced. Whether to refer to the downlink or uplink communication quality may be determined with reference to the application being executed. For example, if the application involves the reception of images or videos for which a downlink information amount is large, or the acquisition of a print job, or the like, the downlink communication quality criteria may be selected; and if the application involves image, video or print job uploading, the uplink communication quality criteria may be selected.

Subsequently, in step S611, the control unit 402 of the STA 105 determines whether or not a User Datagram Protocol (UDP) communication state is set. That is, in the present embodiment, the execution of Multi-Link communication is controlled based on an element indicating whether or not a UDP communication state is set. If UDP communication is in progress, the processing proceeds to step S613, and if UDP communication is not in progress, the processing proceeds to step S614. The UDP communication state is a state in which the STA 105 performs UDP communication, which requires real-time performance for moving images, audio, or the like. UDP communication is unidirectional communication, and unlike Transmission Control Protocol (TCP) communication, it has low reliability, but can transmit data at high speed. Therefore, in a case where communication overlaps that of an application other than the application by which the STA 105 is performing UDP communication, a delay in UDP communication occurs, and when the transmission/reception processing of the STA 105 is not on time, a packet loss will occur. During UDP communication, delays can be reduced by Multi-Link communication. In addition to moving images and audio, in a case where the STA 105 is an image forming apparatus such as a multifunction peripheral or a printer, UDP communication is used for transmitting and receiving IP-FAX images and the like. IP-FAX is a function for communicating images printed by a FAX via Internet Protocol (IP). In step S611, it may be determined that a packet to be received or a packet to be transmitted is a UDP packet. Alternatively, it may be determined whether or not an application that uses UDP is in a UDP communication state based on whether or not the application is being executed. For example, in addition to IP-FAX, applications such as those for audio communication, video distribution, and web conferencing typically use UDP, and it may be determined that the device is in a UDP communication state if one of these particular applications that uses UDP is being executed. Note that a state that is not the UDP communication state is a state in which communication that is not UDP communication is being performed or a state in which communication with another apparatus is not being performed. Communication that is not UDP communication is TCP communication, for example. A function in which TCP communication is used is, for example, a function for receiving a print job or a scan job from another apparatus, or a function for transmitting images obtained by scanning based on a scan job to another apparatus.

When it is determined in step S611 to be a UDP communication state, in step S613 the control unit 402 of the STA 105 records “1” in the UDP communication in progress flag 8022. When it is determined in step S611 to not be a UDP communication state, in step S612 the control unit 402 of the STA 105 records “0” in the UDP communication in progress flag. Specifically, for example, the control unit 402 of the STA 105 records “1” in the UDP communication in progress flag 8022 when transmission of an image by an IP-FAX function is started, and records “0” in the UDP communication in progress flag 8022 when transmission of an image by IP-FAX function is completed. The UDP communication state may be determined by referencing a setting for communication using UDP, and “1” may be recorded in a UDP communication in progress flag in a case where the communication setting is activated, and “0” may be recorded in the UDP communication in progress flag when the communication setting is inactivated.

Subsequently, in step S614, the control unit 402 of the STA 105 determines whether or not a job is being executed in the STA 105. That is, in the present embodiment, the execution of Multi-Link communication is controlled based on an element indicating whether or not a job is being executed in the STA 105. If a job is being executed, the processing proceeds to step S616, and if a job is not being executed, the processing proceeds to step S615. In a case where the STA 105 is an image forming apparatus such as a multifunction peripheral or a printer, the job to be executed in the STA 105 is, for example, a print job or a scan job. A print job is a job that executes printing based on print data received from another STA (for example, the STA 102). The scan job is a job in which a document is scanned based on a scan instruction received from another STA or a scan instruction received from a user by the input unit 404 of the STA 105, and image data obtained by the scanning is transmitted. The presence or absence of a job that is being executed may be determined by referring to, for example, information indicating that there is a job being executed, or may be determined based on the presence or absence of a job by referring to a job queue. In step S616, the control unit 402 of the STA 105 records “1” in the job flag 8023. Meanwhile, in step S615, the control unit 402 of the STA 105 records “0” in the job flag 8023.

Subsequently, in step S617, the control unit 402 of the STA 105 determines whether or not the STA 105 is in a sleep state. If the STA 105 is in the sleep state, the processing proceeds to step S622, and if the STA 105 is not in the sleep state, the processing proceeds to step S618. Since the STA 105 is an image forming apparatus such as a multifunction peripheral or a printer, there are parts, such as a printing unit for printing on a paper medium (not illustrated) or a reading unit for reading a document, to which power need not be shared in a state in which a user is not using the device or a state in which a job is not being executed. In such a state, the sleep state is a state in which the supply of power to some of the hardware configurations included in the STA 105 is stopped, and a clock for operating the hardware configurations included in the STA 105 is stopped, or the frequency of the clock is lowered. That is, the sleep state is a state in which the power consumption of the STA 105 is suppressed. In addition, the normal state indicates a state in which the device is not in the sleep state, and the power consumption is higher than that in the sleep state. Specifically, the normal state is a state in which power is supplied to a larger number of hardware configurations than the number of hardware configurations to which power is supplied in the sleep state. Also, the normal state is a state in which power is supplied to hardware configurations in accordance with a clock with a higher frequency than the clock for supply of power to hardware configurations in the sleep state. In a case where a job is received from another apparatus via the AP 101 or the like in the sleep state, the STA 105 transitions to the normal state and then executes processing (a print, a scan, or the like) based on the job. Note that a sleep state may also occur in an STA 102 that is not an image forming apparatus. For example, when the STA 102 is a terminal apparatus, the backlight intensity of a display unit, which is a part of the hardware configuration, is lowered or turned off in a sleep mode. Such a state may also be included in the sleep state. The determination of whether the device is in the sleep state may be made by referring to information indicating a state of the STA.

Continuing on, in step S618, the control unit 402 of the STA 105 determines whether or not a condition for Multi-Link communication is satisfied. Specifically, if at least one of the communication quality flag 8021 being “bad”, the UDP communication in progress flag 8022 being “1”, and the job flag 8023 being “1” is satisfied, it is determined that the Multi-Link communication condition is satisfied. If not even one of the conditions is satisfied, it is determined that the Multi-Link communication condition is not satisfied. If the Multi-Link communication condition is satisfied, the processing proceeds to step S619, and if the Multi-Link communication condition is not satisfied, the processing proceeds to step S622. In step S619, the control unit 402 of the STA 105 acquires information indicating frequency bands and channels in which affiliated APs other than AP1 belonging to the AP 101 (assumed to be AP2 and AP3) are operating, and specifies the frequency bands and the channels. The processing of step S619 is similar to the processing of step S605. Further, in step S620, the control unit 402 of the STA 105 switches the frequency bands and the channels used for communication to the frequency bands and the channels of the specified AP2 and AP3. Then, the control unit 402 of the STA 105 acquires a Beacon/Probe Response frame of AP2 and AP3 and shares detailed information of each of AP2 and AP3. The processing of step S620 is similar to the processing of step S606. The control unit 402 of the STA 105, in step S621, is connected to AP1, AP2, and AP3 by Multi-Link. The processing of step S621 is similar to the processing of step S607.

Meanwhile, in step S622, the control unit 402 of the STA 105 determines whether or not there is a Multi-Link connection. This determination can be made, for example, by setting information indicating that a Multi-Link connection was made in step S607 or in step S621, and referring to that information. Of course, other information indicating that there is a Multi-Link connection may be referred to. In a case where it is determined that there is a Multi-Link connection, the processing proceeds to step S623, and if it is determined that a Multi-Link connection is not in progress, the processing proceeds to step S624. In step S623, the control unit 402 of the STA 105 disconnects AP2 and AP3 (the APs other than AP1) because the Multi-Link communication condition is not satisfied. In step S624, the control unit 402 of the STA 105 connects to AP1, or does nothing if it is already connected to AP1.

In this way, on the condition that the Multi-Link communication setting is set to “automatic”, a Multi-Link communication is established between the STA 105 and the AP 101 in a case where the Multi-Link communication condition is satisfied, and single link communication is established in a case where it is not satisfied. By doing so, it is possible to keep communication of extra frames for exchanging link information to a minimal an amount as necessary, reduce communication overhead and power consumption, and improve communication reliability. By not performing Multi-Link communication that is not particularly necessary, it is possible to prevent wasteful use of communication resources such as channels shared with other communication apparatuses in the service area. Further, in a case where the communication quality is low, the throughput can be increased by performing the Multi-Link communication. In particular, in a case where the communication quality of a channel in a specific frequency band is low, the communication quality can be improved and the throughput can be improved by using other frequency bands in the Multi-Link communication. Furthermore, during UDP communication, there is a possibility that the target data is being transmitted and received, so that the throughput can be improved by Multi-Link communication, the loss of packets can be prevented, and the like. In a case where the STA is the STA 105, that is, an image forming apparatus, Multi-Link communication is performed while a job for which a large information amount is transmitted is being executed, and thereby a delay of the job caused by the low-throughput communication can be prevented. Further, since it is meaningless for the STA to perform Multi-Link communication when in the sleep state, the Multi-Link communication is not performed in the sleep state, and thus power consumption can be further reduced.

In the procedure of FIG. 6, in step S618, if at least one of the three determination criteria is satisfied, it is determined that the Multi-Link communication condition is satisfied. However, the determination criteria are not limited thereto, and other conditions may be added, or one of the conditions may be replaced with another condition. In addition, in the above-described processing, all of the three determinations (step S608, step S611, step S614) based on the three determination criteria are executed, but limitation is not made to this embodiment, and an embodiment in which at least one of the three determinations is executed may be taken. In step S618, it may be determined whether the condition for Multi-Link communication is satisfied based on the result of the determinations performed out of the three determinations. Specifically, for example, the control unit 402 of the STA 105 may execute only the determination of step S608 among the three determinations and proceed to step S618 immediately after step S609 or step S610. Also, for example, the control unit 402 of the STA 105 may execute only the determination of step S611 among the three determinations and, omitting step S608 to step S610, proceed to step S618 immediately after step S612 or step S613. Also, for example, the control unit 402 of the STA 105 may execute only the determination of step S614 among the three determinations and omit step S608 to step S613. Also, for example, the control unit 402 of the STA 105 may execute only the determination of step S617 among four determinations and omit step S608 to step S616. In addition, the order of the three determinations is not limited to the order of the above-described procedure. In addition, even in a mode in which only a portion of the three determinations is performed, the order of the portion of the determinations may be an arbitrary order. Further, for the processing of FIG. 6, the communication quality referred to in step S608 is executed by the communication quality measuring unit 505 in the block diagram of FIG. 5, and the rest of the processing is executed by the multi-link control unit 501.

In the above description, an embodiment is described in which, in step S602, and step S623 and step S624, only one link is established between the STA 105 and the AP 101. However, limitation is not made to this embodiment. In step S602, and step S623 and step S624, two or more links may be established between the STA 105 and the AP 101. However, in the case of proceeding to step S602, and step S623 and step S624, control is performed so that a smaller number of links than the number of links used for communication when proceeding to step S607, and step S621 are used for communication. Specifically, for example, in step S602, and step S623 and step S624, two links may be established between the STA 105 and the AP 101, and in step S607, and step S621, three links may be established between the STA 105 and the AP 101. In a case where the processing proceeds to step S602, and step S623 and step S624, control may be performed such that communication using two links is executed as communication between the STA 105 and the AP 101. Also, in a case where the processing proceeds to step S607, and step S621, control may be performed such that communication using three links is executed as communication between the STA 105 and the AP 101.

Further, after establishing a plurality of links between the STA 105 and the AP 101, the STA 105 may use only a portion of the plurality of links for communication while maintaining the establishment of the plurality of links. For this reason, for example, three links may be established between the STA 105 and the AP 101 both in step S602, and in step S623 and step S624 as well as in step S607 and step S621. In a case where the processing proceeds to step S602, and step S623 and step S624, control may be performed such that communication using only one of the above three links is executed as communication between the STA 105 and the AP 101. Also, in a case where the processing proceeds to step S607, and step S621, control may be performed such that communication using three links is executed as communication between the STA 105 and the AP 101. However, in the sleep state, there is little merit in establishing a plurality of links. Therefore, for example, in the processing executed in a case where step S617 results in a yes, control may be performed so that only one link is established between the STA 105 and the AP 101. Then, in the processing executed in a case where step S618 results in a no, a plurality of links may be established between the STA 105 and the AP 101, and control may be performed so that only a portion of the plurality of links is used for communication while maintaining the establishment of the plurality of links.

In the above embodiment, it is determined whether or not the device is in the sleep state, and the processing is switched based on the determination result, but limitation is not made to this embodiment. This determination (the determination of step S617) may be omitted. That is, step S618 may be processed immediately after step S615 or step S616. Also, in the above embodiment, the processing of step S608 to step S616 is executed, and the processing is switched based on the result of that processing, but limitation is not made to this embodiment. The processing of step S608 to step S616, and step S618 may be omitted. That is, whether the processing of step S619 is executed or the processing of step S622 is executed may be switched based only on whether the device is in the sleep mode.

### Second Embodiment

The above-described embodiments may be combined to determine the number of connections for Multi-Link communication in accordance with the state of the STA. In a case where the STA is a multifunction peripheral (an image forming apparatus having composite functions such as a printer and a scanner), the communication amount changes depending on the settings of the multifunction peripheral and the operation status of the functions in accordance with the user environment. Therefore, in the multifunction peripheral, it is desirable to determine the number of Multi-Link connections dynamically rather than statically. As a second embodiment, processing for determining the number of connections for Multi-Link communication is described. In the present embodiment, since similar processing to the processing described in the first embodiment is executed in steps other than step S607 and step S621 in the processing in FIG. 6 described in the first embodiment, description thereof is omitted. That is, in the present embodiment, the processing specific to the present embodiment is executed only in step S607 and step S621 among the processes of FIG. 6 described in the first embodiment. Details of the processing executed in step S607 and step S621 in the present embodiment will be described with reference to FIG. 7.

This processing illustrated in FIG. 7 is realized by the control unit 402 of the STA 105, in particular, by a CPU executing a program stored in the storage unit 401. Although the STA 105 is given as an example in the following explanation, similar processing can be executed in the STA 102. In step S701 to step S707, specific individual conditions that constitute a link number reduction condition are confirmed or determined, the number of links is determined in accordance with the condition, and communication is performed over the number of links.

In step S701, the control unit 402 of the STA 105 determines whether or not the job being executed in the STA 105 is a job corresponding to a cloud print. Here, cloud print is a function for executing printing based on a print job received from the cloud server 111A or 111B or the like via the Internet. In a cloud print, print data is downloaded to the STA 105 through the AP 101. That is, a print job received from the cloud server 111A or 111B or the like via the Internet corresponds to a cloud print. Further, as a printing function different from cloud print, there is a function called a local print. Local print is a function of executing printing based on a print job received from a local network to which the STA 105 belongs without going through the Internet. In a local print, for example, the STA 105 receives a job from the STA 102. That is, a print job received without going through the Internet is a print job corresponding to the local print. In a case where it is determined that the job being executed in the STA 105 corresponds to a cloud print, the processing proceeds to step S706. In a case where it is determined that the job being executed in the STA 105 does not correspond to a cloud print, the processing proceeds to step S702. A case where the job being executed in the STA 105 is not a job corresponding to a cloud print is specifically, for example, a case where the job being executed in the STA 105 is a job corresponding to a local print. Also, the case where the job being executed in the STA 105 is not a job corresponding to a cloud print includes a case where the job being executed in the STA 105 is a scan job, and a case where there is no job being executed in the STA 105 or the like. There is a possibility that the amount of communication of a cloud print will be more than a local print due to authentication and the like. Therefore, in the present embodiment, if a print job corresponding to a cloud print is being executed, the number of connections for Multi-Link communication is increased and the job processing speed is improved.

In step S702, the control unit 402 of the STA 105 determines whether or not the data amount of the data to be processed is greater than or equal to a threshold value (for example, 50 megabytes). In a case where it is determined that the data amount of the data to be processed is greater than or equal to the predetermined threshold value, the processing proceeds to step S706, and when it is not determined that the data amount of the data to be processed is greater than or equal to the threshold value, that is, when the data amount of the data to be processed is smaller than the threshold value, the processing proceeds to step S703. The data to be processed is, for example, data based on a job being executed in the STA 105. More specifically, the data to be processed is, for example, print setting information and scan setting information included in a job, image data to be printed, and image data obtained by scanning. In the present embodiment, in a case where the data amount of the data to be processed is greater than or equal to the threshold value, the number of connections for Multi-Link communication is increased, and the job processing speed is improved. Note that the threshold value of the data amount is not limited to the aforementioned 50 megabytes. The amount of data is defined not only by the size (megabytes) of the print or scan data, but also by the number of pages of the print job, and the like, and is not limited thereto. For example, the amount of data may be based on the number of pages.

In step S703, the control unit 402 of the STA 105 determines whether or not the number of jobs held in the STA 105 is greater than or equal to a predetermined threshold value (for example, two). In a case where the number of jobs held in the STA 105 is greater than or equal to the predetermined number, the processing proceeds to step S706, and in a case where the number is not greater than or equal to the predetermined number, the processing proceeds to step S704. In the present embodiment, in a case where there are a plurality of jobs held in the STA 105, the number of connections for Multi-Link communication is increased, and the job processing speed is improved.

In step S704, the control unit 402 of the STA 105 confirms that a predetermined number, for example, two, or more of one or more of the server functions of the STA 105 are activated. The server functions are functions in which the STA 105 operates as a server. Specifically, server functions of the STA 105 include a remote user interface function, a Server Message Block (SMB) function, and a wireless direct function. The remote user interface function is a function for providing an interface screen for remotely operating the STA 105 to another apparatus by the STA 105 operating as an HTTP server. The SMB function is a function for enabling access to scanned images stored in the storage unit 401 and storage of files on the storage unit 401 by the STA 105 operating as an SMB server. The wireless direct function is a function for activating an AP within the STA 105 and directly wirelessly connecting to another apparatus without using going through another AP, by the STA 105 operating as a DHCP server. If two or more server functions are activated, the processing proceeds to step S706, and if less than two server functions are activated, the processing proceeds to step S704. In a case where a plurality of functions are activated, since there is the possibility that communication will be performed by the respective functions, the number of Multi-Link communication connections is increased under the condition that the CPU utilization rate is low, and the job processing speed is thereby improved.

In step S705, the control unit 402 of the STA 105 confirms that the number of communication destination (or communication partner) servers of the STA 105 is a predetermined number, for example two, or more. A communication destination server may be a server which is a partner communicating via the Internet accessible to the STA 105 via the AP 101. A communication destination server is, for example, a DHCP server, an SMB server, or a cloud print server such as the cloud server 111A or 111B. The number of communication destination servers is determined based on whether an operation log, counter information, computer program update information or the like of the STA 105 are settings for communication with a server (not illustrated). If the number of communication destination servers is two or more, the processing proceeds to step S706; otherwise the processing proceeds to step S707. Since there is the possibility that communication will be performed by the respective servers if the number of communication destination servers is two or more, the number of Multi-Link communication connections is increased under the condition that the CPU utilization rate is low, and the job processing speed is thereby improved.

In a case where at least one of conditions on the job type, the job data amount, the number of executed jobs, the number of server functions that are activated, the number of communication destination servers, and the number of persistently connected servers is satisfied, the control unit 402 of the STA 105 determines in step S706 whether or not the CPU utilization rate is greater than or equal to a certain value. The CPU utilization rate can be known by referring to information provided by the operating system, for example. In a case where the CPU utilization rate is greater than or equal to a certain value, the processing load of the STA 105 for processing other than Multi-Link communication is high. Therefore, even if Multi-Link communication would improve throughput, the data will not be able to be fully processed, and because the processing load of Multi-Link communication just increases, it will result in inefficiency. In a case where the CPU utilization rate is greater than or equal to a certain value, the processing proceeds to step S707; otherwise the processing proceeds to step S708.

In a case where none of the conditions on the job type, the job data amount, the number of executed jobs, the number of server functions that are activated, the number of communication destination servers, and the number of persistently connected servers are satisfied, the control unit 402 of the STA 105 performs a Multi-Link connection in step S707 with the AP1 and the AP2. It is similar in a case where the CPU utilization rate is greater than or equal to a certain value. That is, the STA 105 connects to the AP 101 in a state for executing Multi-Link communication by establishing two links, which are links to AP1 and AP2. In a case where the CPU utilization rate is not greater than or equal to a certain value, the control unit 402 of the STA 105 in step S708 connects to AP1, AP2, and AP3 by Multi-Link. In this way, in accordance with the link number reduction condition, the number of links of the multi-link connection is determined to be either 2 or 3, and Multi-Link communication is performed over the determined number of links. Although the number of links is made to be 2 or 3 in this example, it is only necessary to switch between a first number and a second number larger than the first number, and the specific numbers may be other numbers. For example, if the link number reduction condition is satisfied, the number of links is set to a first number, and if not, the number of links is set to a second number larger than the first number. In addition, depending on the condition, the number of links may be set to a third number different from the first number and the second number, or may be set to another number.

Thereafter, in step S709, the control unit 402 of the STA 105 confirms the Multi-Link communication setting. If the Multi-Link communication setting is on, the flowchart is ended, and if it is automatic, the flowchart returns to the procedure of FIG. 6B. As a result, it is possible to connect to the AP 101 through Multi-Link communication in accordance with the Multi-Link communication condition in the procedure of FIG. 6B, and also to change the number of links in the procedure of FIG. 7 in accordance with the communication and processing situations when there is a Multi-Link communication connection.

In this way, in the present embodiment, it is possible to perform Multi-Link communication in which the number of connections (the number of links) for Multi-Link communication is set in accordance with the state of the STA (for example, the communication state and the processing state), so that it is possible to suppress power consumption in a state with less overhead and improve the reliability of communication.

It is not necessary to determine the CPU usage amount in step S706. That is, if the results of the determinations of step S701 to step S705 are yes, the processing may immediately proceed to step S708.

In addition, configuration may be such that not all of the determinations of step S701 to step S705 are executed. That is, configuration may be such that at least one of step S701 to step S705 determination is executed. Specifically, for example, in an embodiment in which only the determination of step S701 is performed, if yes is determined in step S701, the processing proceeds to step S706 immediately, and if no is determined in step S701, the processing proceeds to step S707 immediately. The order in which the determinations of step S701 to step S705 are executed is not particularly limited.

A recording medium in which software program code for realizing the above-described functions is recorded may be supplied to a system or an apparatus, and a computer (a CPU or MPU) of the system or the apparatus may read and execute the program code stored in the recording medium. In this case, the program code itself, which is read from the storage medium, realizes the functions of the above-described embodiment, and the storage medium storing the program code constitutes the above-described apparatus.

As a storage medium for supplying the program code, for example, a flexible disk, a hard disk, an optical disk, a magneto-optical disk, a CD-ROM, CD-R, a magnetic tape, a nonvolatile memory card, a ROM, a DVD, or the like may be used.

Further, the above-described functions may be realized by a computer executing the read out program code, but also, an OS running on the computer may perform some or all of the actual processes based on instructions of the program code to realize the above-described functions. OS is an abbreviation for Operating System.

Further, the program code read from the storage medium may be written into a memory provided in a function expansion board inserted into a computer or a function expansion unit connected to a computer. A CPU included in a function expansion board or a function expansion unit may perform some or all of the actual processing based on instructions of the program code to realize the above-described functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-211517. filed Dec. 14, 2023, which is hereby incorporated by reference herein in its entirety.

What is claimed is:

1. A communication apparatus for performing wireless communication with an external apparatus compliant with an IEEE 802.11be standard, the communication apparatus comprising:
at least one memory storing instructions; and
at least one processor that is in communication with the at least one memory and that, when executing the instructions, cooperates with the at least one memory to execute processing, the processing including:
establishing a link between the external apparatus and the communication apparatus by a communication function compliant with the IEEE 802.11be standard; and
executing, based on a job that the communication apparatus is holding, predetermined processing for controlling whether to execute a first communication using a first plural number of links between the external apparatus and the communication apparatus established by the communication function compliant with the IEEE 802.11be standard as the communication between the external apparatus and the communication apparatus, or to execute a second communication using a second plural number of links smaller than the first plural number between the external apparatus and the communication apparatus established by the communication function compliant with the IEEE 802.11be standard as the communication between the external apparatus and the communication apparatus.

2. The communication apparatus according to claim 1, wherein
the predetermined processing is executed based on whether or not a data amount of a job that is being executed on the communication apparatus is greater than or equal to a predetermined threshold value.

3. The communication apparatus according to claim 2, wherein
based on the data amount of the job that is being executed on the communication apparatus being greater than or equal to the predetermined threshold value, the first communication is executed, and
based on the data amount of the job that is being executed on the communication apparatus not being greater than or equal to the predetermined threshold value, the second communication is executed.

4. The communication apparatus according to claim 1, wherein
the predetermined processing is executed based on whether or not a number of jobs that are being held in the communication apparatus is greater than or equal to a predetermined threshold value.

5. The communication apparatus according to claim 4, wherein
based on the number of jobs that are being held in the communication apparatus being greater than or equal to the predetermined threshold value, the first communication is executed, and
based on the number of jobs that are being held in the communication apparatus being greater than or equal to the predetermined threshold value, the second communication is executed.

6. The communication apparatus according to claim 1, wherein
the predetermined processing is executed based on whether or not a job that is being executed on the communication apparatus is a job obtained from a server via the Internet.

7. The communication apparatus according to claim 6, wherein
the first communication is executed based on the job that is being executed on the communication apparatus being a job obtained from a server via the Internet, and
the second communication is executed based on the job that is being executed on the communication apparatus not being a job obtained from a server via the Internet.

8. The communication apparatus according to claim 1, wherein
the predetermined processing is executed further based on a number of functions that the communication apparatus has activated and for which the communication apparatus operates as a server.

9. The communication apparatus according to claim 1, wherein
the predetermined processing is executed further based on a number of servers with which the communication apparatus communicates via the Internet.

10. The communication apparatus according to claim 1, wherein
the predetermined processing is executed further based on a utilization rate of a processor that the communication apparatus has.

11. The communication apparatus according to claim 1,
further comprising a second control unit configured to execute specific processing for controlling whether to execute the first communication or the second communication as the communication between the external apparatus and the communication apparatus, or to execute a third communication using a third number of links smaller than the first plural number and the second plural number between the external apparatus and the communication apparatus established by the communication function compliant with the IEEE 802.11 standard.

12. The communication apparatus according to claim 11, wherein
the specific processing is executed based on a communication quality in communication using at least one link between the external apparatus and the communication apparatus, and
based on the communication quality being a first quality, control is performed to execute the first communication or the second communication as the communication between the external apparatus and the communication apparatus, and
based on the communication quality being a second quality better than the first quality, control is performed to execute the third communication as the communication between the external apparatus and the communication apparatus.

13. The communication apparatus according to claim 11, wherein
the specific processing is executed based on whether or not the communication apparatus is in a User Datagram Protocol (UDP) communication state, and
based on the communication apparatus being in the UDP communication state, control is performed to execute the first communication or the second communication as the communication between the external apparatus and the communication apparatus.

14. The communication apparatus according to claim 11, wherein
the specific processing is executed based on whether or not a print job or a scan job is being executed in the communication apparatus, and
based on a print job or a scan job being executed in the communication apparatus, control is performed to execute the third communication as the communication between the external apparatus and the communication apparatus.

15. The communication apparatus according to claim 11, wherein
the specific processing is executed based on whether or not the communication apparatus is in a sleep state, and
based on the communication apparatus being in the sleep state, control is performed to execute the third communication as the communication between the external apparatus and the communication apparatus.

16. The communication apparatus according to claim 11, wherein
the third number is 1.

17. The communication apparatus according to claim 1, further comprising a print unit configured to execute printing.

18. A non-transitory computer-readable storage medium storing a program for causing a computer to function as a communication apparatus for performing wireless communication with an external apparatus compliant with an IEEE 802.11be standard, wherein
the program causes the computer to execute steps comprising:
establishing a link between the external apparatus and the communication apparatus by a communication function compliant with the IEEE 802.11be standard; and
executing, based on a job that the communication apparatus is holding, predetermined processing for controlling whether to execute a first communication using a first plural number of links between the external apparatus and the communication apparatus established by the communication function compliant with the IEEE 802.11be standard as the communication between the external apparatus and the communication apparatus, or to execute a second communication using a second plural number of links smaller than the first plural number between the external apparatus and the communication apparatus established by the communication function compliant with the IEEE 802.11be standard as the communication between the external apparatus and the communication apparatus.

19. A method for controlling a communication apparatus for performing wireless communication with an external apparatus compliant with an IEEE 802.11 standard, the method comprising:
establishing a link between the external apparatus and the communication apparatus by a communication function compliant with the IEEE 802.11 standard; and
executing, based on a job that the communication apparatus is holding, predetermined processing for controlling whether to execute a first communication using a first plural number of links between the external apparatus and the communication apparatus established by a communication function compliant with an IEEE 802.11be standard as the communication between the external apparatus and the communication apparatus, or to execute a second communication using a second plural number of links smaller than the first plural number between the external apparatus and the communication apparatus established by the communication function compliant with the IEEE 802.11be standard as the communication between the external apparatus and the communication apparatus.
